(19) United States
(12) Patent Application Publication
(10) Pub. No.: US 2019/0145931 A1
(43) Pub. Date: May 16, 2019

(54) METHODS AND SYSTEMS FOR NONDESTRUCTIVE MATERIAL INSPECTION

(71) Applicant: ExxonMobil Research and Engineering Company, Annandale, NJ (US)

(72) Inventors: Lang Feng, New York, NY (US); Qiuzi Li, Clinton, NJ (US); Harry W. Deckman, Clinton, NJ (US); Paul M. Chaikin, New York, NY (US); Neeraj S. Thirumalai, Easton, PA (US); Shiun Ling, Washington, NJ (US)

(21) Appl. No.: 16/164,955

(22) Filed: Oct. 19, 2018

Related U.S. Application Data
(60) Provisional application No. 62/585,177, filed on Nov. 13, 2017.

(51) Int. Cl. G01N 27/82

(52) U.S. Cl. CPC G01N 27/82

(57) ABSTRACT

A device for detecting one or more material qualities of a sample composed of at least one hysteretic magnetic material includes a magnet configured to provide a DC magnetic field which has a spatially varying magnetic field in at least a portion of the regions of interest, two or more suitable sensors disposed at locations with different magnetic field strengths in the regions of interest configured to receive magnetic responses. The device can also include a processor, configured to execute a method, the method comprising recording magnetic responses from two or more suitable sensors disposed at the said different locations, and correlating all the said received magnetic responses to one or more material qualities of the said sample composed of at least one hysteretic ferromagnetic material.

### CROSS-REFERENCE TO RELATED APPLICATIONS

This application claims priority to U.S. Provisional Application No. 62/585,177 entitled “Methods And Systems For Nondestructive Material Inspection” filed on Nov. 13, 2017, which is hereby incorporated by reference here in its entirety. This application is related to three other co-pending U.S. provisional applications, filed on Nov. 13, 2017: U.S. Provisional Application No. 62/585,167 entitled “Methods And Systems For Nondestructive Material Inspection”; U.S. Provisional Application No. 62/585,185 entitled “Methods Of Using Nondestructive Material Inspection Systems”; and U.S. Provisional Application No. 62/585,191 entitled “Methods Of Using Nondestructive Material Inspection Systems”, each of which are hereby incorporated by reference here in its entirety.

### FIELD

The present disclosure relates to material inspection, more specifically to nondestructive material inspection.

### BACKGROUND

Systems and methods to evaluate hard spots and/or other suitable material qualities (e.g., in pipeline steel or other suitable materials) for nondestructive inspection of pipeline, piping, steel plates, welded structures, and welds of different types that can include but not limited to girth welds, fillet welds, lap welds, and butt welds are valuable in determining material integrity (e.g., pipeline integrity). Such systems and methods for example, can obtain information on welds and pipeline materials nondestructively on such materials. Currently, pipeline inspection gauges and tools (PIGS) are being used to perform nondestructive inspection to detect anomalies and flaws in a pipe, such as cracks and hard spots. Similarly, welds are non-destructively inspected using technologies including magnetic particle testing, ultrasonic testing and eddy current testing. The most commonly used nondestructive inspection technologies include magnetic flux leakage (MFL) and ultrasonic crack detection tool (UT). These inspection technologies are based on the principle that the anomalies and flaws possess some material properties that are detectably different from that of the bulk material of the pipeline, e.g., MFL detects the leaked magnetic flux due to difference in magnetic permeabilities, and the UT detects the reflected ultrasonic signals due to difference in mechanical vibration behaviors. Because of the importance of material integrity as well as material and weld quality, there is a continuous need to further improve the art of nondestructive material inspection technologies, through improving current technologies, as well as developing new inspection technologies. The present disclosure provides a new inspection technology solution for this need.

### SUMMARY

In accordance with at least one aspect of this disclosure, a device for detecting one or more material qualities of a sample composed of at least one hysteretic ferromagnetic material. The device includes a magnet configured to provide a DC magnetic field which has a spatially varying magnetic field in at least a portion of the regions of interest, and two or more suitable sensors disposed at locations with different magnetic field strengths in the regions of interest configured to receive magnetic responses. In one embodiment, it can be a first sensor disposed at a first location relative to the magnet and configured to receive a first magnetic response, and a second sensor disposed at a second location relative to the magnet and configured to receive a second magnetic response. The device can also include a processor, configured to execute a method that comprises recording magnetic responses received from the two or more suitable sensors disposed at the said different locations, and correlating all the said received magnetic responses to one or more material qualities of the said sample composed of at least one hysteretic ferromagnetic material.

In certain embodiments, the device can include an indicator configured to indicate to a user the one or more material qualities of the sample. In another embodiment, the device can send indications in real time to a remote user through wireless communication technology. In yet another embodiment, the device can record all indications, for later retrieval and download either on-site or at remote locations for post processing.

In certain embodiments, the one or more material qualities can include, but is not limited to, a material phase of the hysteretic ferromagnetic material or non-hysteretic material. In certain embodiments, the one or more material qualities can include, but is not limited to, a material flaw.

The hysteretic ferromagnetic material can include any material in which the relationship between magnetic field strength and magnetization is not linear. In certain embodiments, the hysteretic ferromagnetic material can include, but is not limited to steel, nickel, cobalt, silicon steel, and their alloys, such as a variety of carbon steels.

In certain embodiments, the non-hysteretic material can include, but is not limited to, air, aluminum, austenitic stainless steel, duplex stainless steel, and high manganese steel.

In certain embodiments, the material phase can include, but is not limited to, at least one of austenite, martensite, ferrite, pearlite, bainite, lath bainite, acicular ferrite, and quasi-polygonal ferrite with different chemical compositions and/or crystallographic orientations.

In certain embodiments, the magnet that provides a DC magnetic field can include, but is not limited to, one or more permanent magnets that can form a horseshoe magnet. Any other suitable magnet type (e.g., electromagnet) or shape is contemplated herein. In certain embodiments, the magnet to provide a DC magnetic field could be made of, but is not limited to, a combination of multiple types of magnets, such as electromagnets, permanent magnets such as Neodymium magnets and ceramic magnets, and superconducting magnets.

The spatially varying magnetic field can include, but is not limited to, the magnetic field strengths that vary at different locations relative to the magnet. In certain embodiments, the spatially varying magnetic field can include the difference of magnetic field strengths in the center and the trailing side of the magnet.

The regions of interest can include, but are not limited to, the following: the center of the magnet close to the material being inspected, the trailing side of the magnet close to the material being inspected, etc.

In certain embodiments, two or more suitable sensors can be disposed at different locations relative to the magnet. Each sensor can include, a multi-axis (e.g., three axis) Hall sensor or a cesium atomic magnetometer, however any suitable sensor for sensing a magnetic field is contemplated herein. In one embodiment, one of the two or more suitable sensors can be disposed at the center of the horseshoe magnet. One of the two or more suitable sensors can be disposed outside of the horseshoe magnet. For example, one of the two or more suitable sensors can be disposed on the trailing side of the horseshoe magnet.

Magnetic responses can include, but is not limited to, the magnetic fields measured by all the said suitable sensors. In certain embodiments, magnetic responses can also include the spatially varying magnetic response measured at the said suitable sensor as the said suitable sensor moving in the regions of interest.

Recording magnetic responses can include, but is not limited to, recording magnetic responses real time with a computer on board. Recording magnetic responses could also include, but is not limited to, storing at the time of signal acquisition to a computer readable storage media with sufficient information which can be used for post processing.

In certain embodiments, the device could be embedded to handheld tool, a computer-controlled automatic moving platform such as a robotic arm, or an externally driven moving tool such as a pipeline inspection gauge (PIG). In a specific embodiment, the device can be incorporated on a pipeline inspection gauge to detect the hysteretic ferromagnetic material and identify regions with higher hardness or metal loss or cracks feature of the pipe.

In accordance with at least one aspect of this disclosure, a method for determining one or more qualities of a sample composed of at least one hysteretic ferromagnetic material can include providing a DC magnetic field from a magnet to the said sample composed of at least one hysteretic ferromagnetic material, recording the magnetic responses received at two or more suitable sensors disposed at locations with different magnetic field strengths in the regions of interest; and correlating all the said received magnetic responses to one or more material qualities of the said sample composed of at least one hysteretic ferromagnetic material. In one embodiment, the method can include receiving a first magnetic response at a first sensor disposed at a first location, receiving a second magnetic response at a second sensor, and correlating both of the first and the second magnetic responses to one or more material qualities of the sample.

The method can include moving the magnet, and two or more suitable sensors together along a surface to be analyzed. In one embodiment, correlating the magnetic responses can include, but is not limited to, correlating all the magnetic responses to the presence of a material phase. In another embodiment, correlating can include, but is not limited to, correlating all the magnetic responses to the occurrence of a material flaw.

In accordance with at least one aspect of this disclosure, a non-transitory computer readable medium can include instructions for performing a method. The method comprising recording magnetic responses from two or more suitable sensors disposed at locations with different magnetic field strengths in the regions of interest, and correlating all the said received magnetic responses to one or more material qualities of the said sample composed of at least one hysteretic ferromagnetic material. Correlating can include, but is not limited to, correlating all the said received magnetic responses to a material phase. Correlating can also include, but is not limited to, correlating all the said received magnetic responses to a material flaw. The method can include sending an indicator signal if the detected material quality deviates from the acceptable range of material quality. The method can also include sending an indicator signal to remote user if the detected material quality deviates from the acceptable range of material quality. The method can also include recording an indicator signal for later retrieval or download for post-processing and follow-up actions if the detected material quality deviates from the acceptable range of material quality.

These and other features of the systems and methods of the subject disclosure will become more readily apparent to those skilled in the art from the following detailed description taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIGS. 1A and 1B show magnetic hysteresis curves for ferrite (solid line) and martensite (dot-dashed line), wherein in FIG. 1A, full hysteresis curves for ferrite (solid line) and martensite (dot-dashed line) are shown; wherein in FIG. 1B, a zoom-in of initial magnetization curves for ferrite (solid line) and martensite (dot-dashed line) are shown.

FIG. 2A is a schematic view of an embodiment of a device in accordance with this disclosure;

FIG. 2B shows center sensor measurements of the magnetic flux along X-axis for different flaws, including that measured with different thicknesses of air gap, and that measured with ferrite coupon, and martensite coupon.

FIG. 3A shows the experimental data of peak magnetic flux measured with different thicknesses of air gap;

FIG. 3B shows computer simulation results of peak magnetic flux with different thickness of air gap;

FIG. 4A-4D shows magnetic flux density measurements for a 308 μm air gap, wherein FIGS. 4A and 4B show the experimental data, wherein FIGS. 4C and 4D show the computer simulation results, wherein FIGS. 4A and 4C plot the magnetic flux density measured by the trailing sensor, and wherein FIGS. 4B and 4D plot the magnetic flux density measured by the center sensor;

FIGS. 5A and 5B show experimental measurement of magnetic flux in presence of martensite or 38 μm air gap, wherein FIG. 5A shows magnetic flux density measured by the center sensor, and FIG. 5B shows magnetic flux density measured by the trailing sensor;

FIGS. 6A and 6B show representations of a magnetic detection system used in the computer simulation, wherein FIG. 6A shows a schematic diagram of the system that comprises a horseshoe permanent magnet moving along the wall of a steel pipe, and FIG. 6B shows a zoom-in of FIG. 6A when the permanent magnet passes a flaw;

FIGS. 7A-7D shows a 2D axial symmetric computer simulation of a horseshoe magnet on the steel pipe wall, wherein FIGS. 7A and 7B correspond to the vertical z-component and the horizontal r-component of magnetic flux density in the horseshoe magnet and pipe wall in the presence of 4.35 mm martensite phase, and wherein FIGS. 7C and 7D correspond to the vertical z-component and the horizontal r-component of magnetic flux density in the presence of 38 μm air gap, respectively; and

FIGS. 8A-8D shows a 2D axial symmetric computer simulation results for multi-point sensing and low magnetic flux detection of martensite/air gap phase, wherein FIGS. 8A and 8B show simulation of the vertical z-component of magnetic flux measured by the magnetic sensor with maximum magnetic flux around 0.2 T in the pipeline wall, and wherein FIGS. 8C and 8D show the same computer simulation for the horizontal r-component of magnetic flux measured by the magnetic sensor.

### DETAILED DESCRIPTION

All numerical values within the detailed description and the claims herein are modified by “about” or “approximately” the indicated value, and take into account experimental error and variations that would be expected by a person having ordinary skill in the art. The current invention relates to methods and apparatus to detect magnetic response of a sample composed of at least one hysteretic ferromagnetic material. The magnetic response of such a sample is given by the equation

B(x)=μ₀(H(x)+M(x))=F(H(x))

where H(x) is the applied magnetic field strength (unit of ampere/meter) which can vary with position (x) in space, M(X) is the magnetization (unit of ampere/meter) which depends on position (x) as well as the initial magnetization state of the material, μ₀ is the magnetic permeability constant (unit of henry/meter), B(x) is the magnetic flux density (unit of Tesla), and F(H(x)) is a function that depends on H(x) as well as the initial magnetization state of the material. This type of dependence is seen in static applied magnetic fields as well magnetic fields that change relatively slowly with time. Currently, practiced magnetism based inspection tools, such as magnetic flux leakage (MFL), are generally configured to apply a magnetic field through the steel specimen, and use a sensor located adjacent to the steel specimen to detect the resulting “leakage” of the B(x) from the steel specimen. The leakage is typically measured at one point in space, or for a pipe with multiple sensors configured around the inner circumference of the pipe in an approximately planar array. For magnetic flux leakage tool the magnetic response (flux leakage) is measured in a region with high flux density in the hysteretic ferromagnetic material. Anomalies and flaws such as inhomogeneities (cracks or hard spots) or changes in the composition of the ferromagnetic material alter the flux leakage. Many types of anomalies and flaws found in ferromagnetic material (such as cracks or hard spots) are difficult to detect using current magnetism based inspection technologies such as MFL, because these anomalies and flaws do not induce sufficiently large change in magnetic flux leakage. The present invention overcomes this limitation by using two or more suitable sensors which are located in proximity to regions adjacent to the specimen that have higher values of the B(x), as well as regions that have lower values of the B(x). In one embodiment two sensors can be used to measure two different leakage B. In another embodiment multiple sensors can be used to measure multiple values of the leakage B. In some cases two arrays of sensors can be positioned to perform measurements near regions having higher and lower B, respectively. This configuration is particularly useful when inspecting pipelines. It is also possible to utilize multiple arrays of sensors to measure regions adjacent to steel pipeline wall that have multiple applied B. In one embodiment, the higher value of the B is higher than 10 T, preferably higher than 1 T, preferably higher than 0.1 T. In one embodiment, the lower value of the B can be lower than 0.5 T, preferably lower than 0.05 T, lower than 0.005 T, or even lower than 0.0005 T. In one embodiment, the distance between flux leakage sensor and the specimen is less than 20 centimeters, preferably less than 1 centimeter, and even more preferably less than 0.1 centimeters. In one embodiment, the distance between the two or more suitable sensors is less than 1 meter, preferably less than 0.1 meters, and could also be less than 0.01 meters.

Examples of anomalies, flaws, and qualities in samples that can be detected using the systems, devices, and method of the present invention include, but are not limited to, the hardness of welds and changes therein, the hardness of the material and changes therein used to produce or in pipes or similar structures, the grade of the material used to produce or in pipes or similar structures, the type of weld, the hardness of the material and changes therein, the presence of a material phase in the material (e.g., the presence of a hard steel phase such as martensite or bainite in carbon steel, nonhysteretic material phases in hysteretic ferromagnetic materials and hysteretic magnetic material phases in nonhysteretic materials), the presence of hard spots in the material, the presence of metal loss or cracks in the material (e.g., stress corrosion cracks), the presence of defects in the material, and combinations thereof.

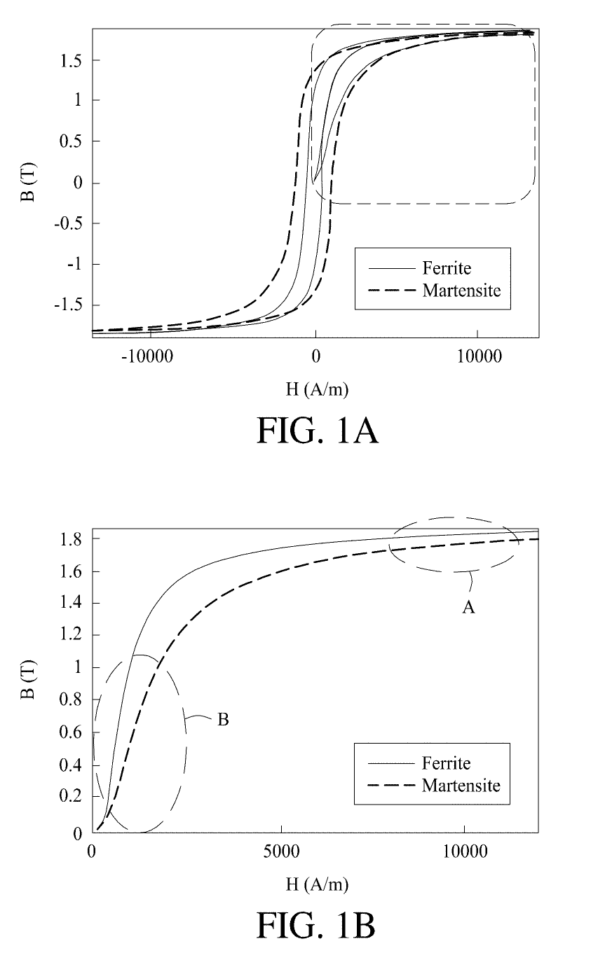

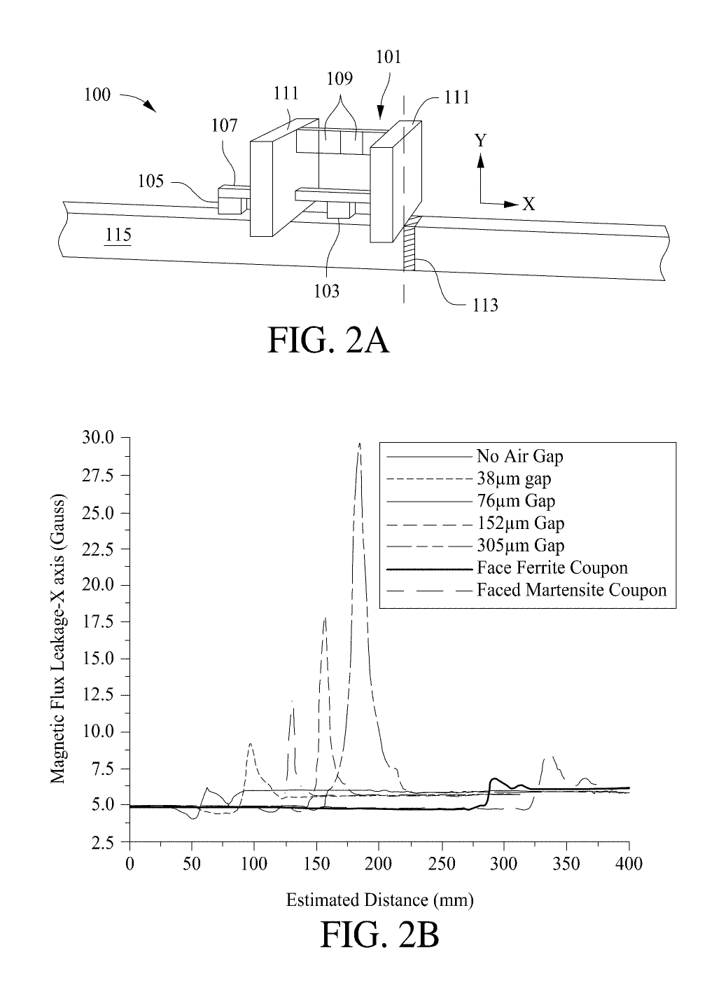

Reference will now be made to the drawings wherein like reference numerals identify similar structural features or aspects of the subject disclosure. For purposes of explanation and illustration, and not limitation, an illustrative view of an embodiment of a method in accordance with the disclosure is shown in FIG. 2 and is designated generally by reference character 100. Other embodiments and/or aspects of this disclosure are shown in FIGS. 1A, 1B, and FIGS. 3A-8D. The systems and methods described herein can be used to determine a quality of a material (e.g., a material phase and/or anomalies and flaws in a metal pipeline or a metal component (e.g., steel metal plates, bolts, forgings, castings, and the like)).

In the past few decades, pipeline inspection tools, known as PIGs, have been used to perform nondestructive inspection of steel pipelines to detect cracks in the pipe wall. The most widely used nondestructive inspection technology is the magnetic flux leakage (MFL). The currently available MFL is not designed to, and is not capable of distinguishing the metallurgy phases commonly found in pipeline steels, the ferrite, and martensite phases. The reason is that the current MFL applies high magnetic field to the steel pipeline wall, but the magnetic properties of martensite and ferrite phases are almost indistinguishable under high magnetic modulation. The magnetic properties between martensite and ferrite phases are larger under low magnetic modulation, but still cannot be detected using the currently available low field magnetic flux leakage techniques, which rely on a single point measurement on the magnetic hysteresis loop that severely limits the measurement sensitivity.

This disclosure is based on results obtained from extensive experimentation and computer simulation, and embodiments of multipoint sensing and low magnetic flux systems are disclosed and can be used for detecting and distinguishing magnetic materials with different hysteresis curves, e.g., differentiating a hard phase or metal loss feature (e.g., a gap, or a crack) from a soft ferrite phase. The fundamental principle of this method is based on the fact that the magnetization and demagnetization processes in hard phase are different to that in a metal loss feature. In other words, the magnetization and demagnetization processes in hard phases are irreversible, hysteretic, and are functions of external magnetic field, whereas that in the metal loss feature are reversible, non-hysteretic, and independent of external field because the magnetic permeability of a metal loss feature is independent of external magnetic field. Moreover, the magnetic properties of the ferrite and martensite phases both strongly depend on the external magnetic field, but they have differences that are most pronounced under low magnetic modulation. This unique fingerprint can be useful for distinguishing a hard phase from a soft ferrite phase, as well as for distinguishing the metal loss feature from both martensite and ferrite phases in steels. Any other use is contemplated herein.

In the pipeline and oil and gas industry, carbon and low alloy steels are commonly used in the construction of pipelines. Generally, soft ferrite is the dominating phase in these steels. A hard phase such as the martensite phase could form when these steels have been subjected to rapid quenching from high temperature (e.g., above 900° C.) to room temperature. Such rapid quenching could happen either intentionally or accidentally during common steel processing or welding, such as steel component (e.g., steel metal plates, bolts, forgings, castings, and the like) manufacturing or electrical resistance seam welding process, for example. The presence of hard phase in steels can be particularly disadvantageous because it is more susceptible to cracking and failures than the soft ferrite phase. As a result, a nondestructive technique to detect and differentiate martensite from ferrite in the steels is valuable to the industry. Embodiments may be used to detect the difference in magnetic hysteresis parameters between ferrite and martensite phases and differentiate them.

FIGS. 1A and 1B show the magnetic hysteresis responses of ferrite and martensite phases generated using computer simulations. The hysteresis models used are commonly known as the J-A model. There are five parameters in the J-A model to describe the hysteretic response of a specific material, and in our simulations these five parameters have been obtained by best fitting the J-A hysteresis curves to suitable experimental data from literature. For ferrite and martensite phases, two different sets of parameters were obtained and the full hysteresis curves are generated using computer simulation, and the results are shown in FIG. 1A. The solid curve is for the ferrite phase and the dot-dashed curve is for the martensite phase.

A COMSOL MULTIPHYSICS® package was used to perform finite element based computer simulation magnetic behaviors and responses of systems that contain hysteretic ferromagnetic steel phases, ferrite and martensite phases, which have magnetization and demagnetization behaviors as shown in FIG. 1A. The computer simulation incorporates a full Maxwell equation solver with five J-A parameters to account for the full hysteretic ferromagnetic properties of both ferrite and martensite phases. The multi-point sensing and low magnetic flux technique, uses the properties of the magnetic hysteresis loop in the region of FIG. 1A inside the black dashed-line square. FIG. 1B is a zoom in of the initial part of the magnetization curves shown in FIG. 1A. Current magnetic sensing devices (e.g., in MFL inspection tool) generally use high magnetic saturation field, shown as the region A in FIG. 1B. In this high magnetic field regime, the magnetic properties between ferrite and martensite are very similar. Embodiments disclosed herein instead perform measurement in the low magnetic field regime, shown as the region B in FIG. 1B. In this low magnetic field regime, the difference in the magnetic properties between ferrite and martensite phases is more pronounced, which allows for improved accuracy in distinguishing these two phases. In certain embodiments disclosed herein, the low magnetic field region is attained by using a magnet with low magnetic flux (e.g., a permanent magnet) to measure magnetic responses with multiple sensors.

Referring to FIG. 2A, a device 100 for detecting one or more material qualities of a sample composed of at least one hysteretic ferromagnetic material 115 includes a magnet 101 configured to provide a DC magnetic field. The device 100 includes a first sensor 103 disposed at a first location relative to the magnet 101 and configured to receive a first magnetic response. The device 100 includes and a second sensor 105 disposed at a second location relative to the magnet 101 and configured to receive a second magnetic response. The first and second sensors 103, 105 are held in place with a bar 107.

The device 100 can also include a processor configured to execute a method, the method comprising, but is not limited to, receiving the magnetic responses from two or more suitable sensors disposed at the said different locations, recording these received magnetic responses, and correlating all the said received magnetic responses to one or more material qualities of the said hysteretic ferromagnetic material being inspected. In certain embodiments, the method can include receiving a first magnetic response from the first sensor 103 disposed at the first location, receiving a second magnetic response from the second sensor 105, and correlating both of the first magnetic response and the second magnetic response to one or more material qualities of a sample 115. In certain embodiments, the material being inspected can include a hysteretic ferromagnetic material or a non-hysteretic material. A hysteretic ferromagnetic material can include any material in which the relationship between magnetic field strength and magnetization is not linear. In certain embodiments, a hysteretic ferromagnetic material can include, but is not limited to steel, nickel, cobalt, silicon steel, and their alloys, such as a variety of carbon steels. In certain embodiments, the non-hysteretic material can include, but is not limited to, air, aluminum, austenitic stainless steel, duplex stainless steel, and high manganese steel. The one or more material qualities of interest can include, but is not limited to, a material phase of the hysteretic ferromagnetic material or non-hysteretic material. In certain embodiments, a material phase can include, but is not limited to, at least one of austenite, martensite, ferrite, pearlite, bainite, lath bainite, acicular ferrite, and quasi-polygonal ferrite.

The device 100 can include an indicator (e.g., one or more LEDs, a display, a readout, an audible indicator, a tactile indicator, or any suitable indicator) configured to indicate to a user the one or more material qualities of the sample 115. In certain embodiments, the device 100 can send indications in real time to a remote user through wireless communication technology. In yet another embodiment, the device 100 can record all indications, for later retrieval and download either on-site or at remote locations for post processing.

In certain embodiments, the material phase, 113, can include, but is not limited to, at least one of austenite, martensite, pearlite, bainite, lath bainite, acicular ferrite, and quasi-polygonal ferrite with different chemical compositions and/or crystallographic orientations. In certain embodiments, the material phase 113 can include, but is not limited to, a material flaw (e.g., a metal loss feature a crack, corrosion caused pit or wall thinning, etc.).

Correlating can include, but is not limited to, correlating all the received magnetic responses from the sensors to a material phase. Correlating can include, but is not limited to, correlating all the received magnetic responses from the sensors to a material flaw.

The device could be embedded to a handheld tool, a computer-controlled automatic moving platform such as a robotic arm, or an externally driven moving tool such as a pipeline inspection gauge (PIG). In one embodiment, the device can be incorporated on a pipeline inspection gauge to identify pipeline sections more susceptible to cracking, by detecting the presence of certain hysteretic ferromagnetic material having higher hardness, or the presence of certain material flaws.

In certain embodiments, the magnet 101 includes one or more permanent magnets 109. The one or more permanent magnets 109 can form a horseshoe magnet (e.g., with metal plates 111). Any other suitable magnet type (e.g., electromagnet) or shape is contemplated herein. In certain embodiments, the magnet 101 to provide a DC magnetic field could be made of, but is not limited to, a combination of multiple types of magnets, such as electromagnets, permanent magnets such as Neodymium magnets and ceramic magnets, and superconducting magnets.

The spatially varying magnetic field can include, but is not limited to, the magnetic field strengths that vary at different locations relative to the magnet. In certain embodiments, the spatially varying magnetic field can include the difference between the local magnetic field strengths at the center of the magnet 109 (e.g., measured by sensor 103) and that are behind the magnet 109 (e.g., measured by sensor 105).

The regions of interest can include, but are not limited to, the following: the center of the magnet close to the material being inspected, the trailing side of the magnet close to the material being inspected, etc.

In certain embodiments, the first sensor 103 can be disposed in a center of the horseshoe magnet close to the material being inspected. The second sensor 105 can be disposed on the trailing side of the horseshoe magnet close to the material being inspected. For example, the second sensor 105 can be disposed on the trailing side of the horseshoe magnet, wherein the device 100 is moved from left to right along the surface of the material 115 in the embodiment shown. The first sensor 103 and second sensor 105 can each include a multi-axis (e.g., three axis) Hall sensor or a cesium atomic magnetometer; however any suitable sensor for sensing a magnetic field is contemplated herein.

Magnetic responses can include, but are not limited to, the magnetic fields measured by all the said suitable sensors. In certain embodiments, magnetic responses can also include the spatially varying magnetic response measured at the said suitable sensor as the said suitable sensor moving in the regions of interest.

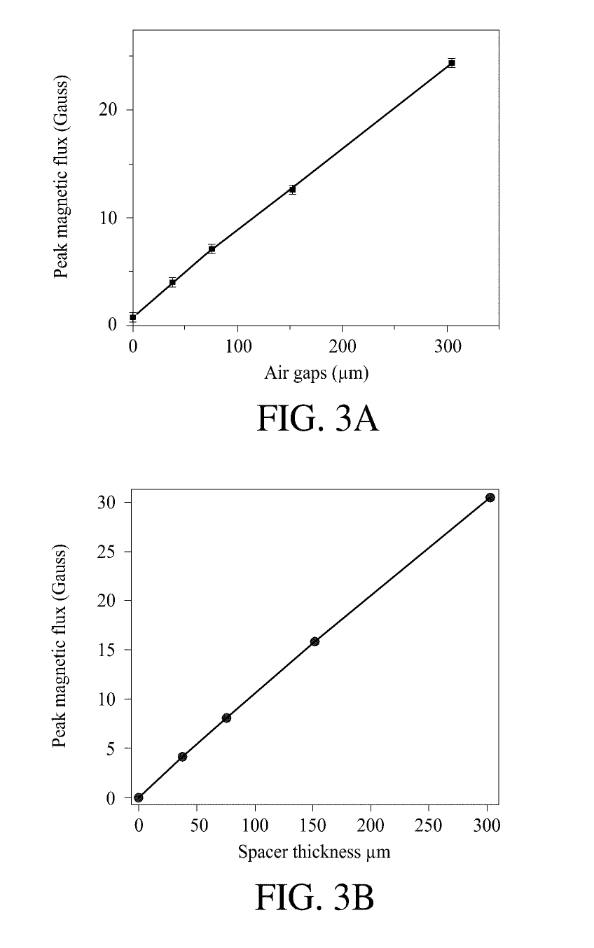

Computer simulations were performed to evaluate the magnetic behaviors of the system shown in FIG. 2A, and the simulation results are validated by comparing them with experimental measurements, and the results are shown in FIGS. 2B and 3A-3B. This experimental set up is described below with reference to the embodiment shown in FIG. 2A. The experimental setup included two 3-axis Hall sensors are used to measure magnetic flux densities. The first one was used as the center sensor 103, and the second one was the trailing sensor 105.

In the experiment, a carbon steel bar was used as the material 115 that was being inspected. As shown in FIG. 2A, the forward moving direction of the magnet 101 was defined as the X-axis direction; the Y-axis was defined to be the direction perpendicular to the material 115. In the experiment, the magnet 101 was moved along the X-axis with a speed of about 1 cm/s. The embodiment of the magnet 101 in this experiment includes four cubic permanent magnets 109 having dimensions 1.27 cm×1.27 cm×1.27 cm, and two steel plates 111 with having thickness of 1.27 cm. The carbon steel bar 115 in this experiment had rectangular cross-section dimension of 2.54 cm×3.81 cm, which match the dimensions of the ferrite and martensite coupons used in this study. The carbon steel bar 115 has a gap for use to simulate the flaw 113. A flaw comprised of the ferrite or martensite phase was simulated by inserting the corresponding ferrite or martensite coupon into the gap 113 between the carbon steel bars. A crack or metal loss feature type flaw was simulated by leaving the gap at 113 location open. And the case of no flaw occurrence was simulated by having closing the gap 113 by pushing the carbon steel bars 115 together. The distance between the trailing sensor 105 and the magnet 101 is 2.54 cm. The distance of both center sensor and trailing sensor from the carbon steel bar is about 1 mm.

The cubic magnets 109 include a magnetic flux of about 0.7 Tesla at their pole surface. The two steel plates 111 are wide enough in order to reduce the amplitude of the magnetic flux density applied in a carbon steel bar 115. FIG. 2A shows the experimental equipment configuration with which the center sensor 103 was used to measure the magnetic response due to different types of flaws 113, such as the martensite phase and the metal loss or cracks (e.g., air gap).

Control experiments were performed, in which the device containing the magnet 101 was moved along the carbon steel bars 115, and the magnetic flux density was measured with sensors 103 and 105. In the first part of the control experiment, the gap 113 in the carbon steel bars was closed (i.e., in FIG. 2A, having the two ends of carbon steel bars 115 touching each other, so that there is no air gap between these two ends). In the second part of the control experiment, a ferrite coupon was inserted and fitted into the gap 113 between the two carbon steel bar ends. In both cases, the measured magnetic flux density only varies within 1 Gauss (0.0001 Tesla) because the magnetic property of the ferrite coupon is close to that of the carbon steel bar. Similar experiments were also carried out in which a martensite coupon was inserted and fitted into the gap 113 between the two carbon steel bar ends. The magnetic flux measured by sensor 103 is shown in FIG. 2B, which shows a pronounced peak in the presence of various air gaps and the martensite coupon. In addition, the height of the peak increases with the air gap thickness. Both ferrite and martensite coupons were faced, such that when these coupons are inserted into the gap 113, these coupons have good fit with minimal air gaps with the two carbon steel bars 115.

In accordance with at least one aspect of this disclosure, a method for determining one or more qualities of a sample composed of at least one hysteretic ferromagnetic material can include providing a DC magnetic field from a magnet to the hysteretic ferromagnetic material, receiving a first magnetic response at a first sensor disposed at a first location, receiving a second magnetic response at a second sensor disposed at a second location, and correlating both of the first magnetic and the second magnetic responses to one or more material qualities of the sample. A variation of this embodiment includes performing similar measurement on a hysteretic ferromagnetic material that has been degaussed. A DC magnetic field is a magnetic field that is not varying over time, and a degaussing magnetic field is a time-varying magnetic field that is used to eliminate residual magnetization of a material.

In accordance with at least one aspect of this disclosure, a non-transitory computer readable medium can be used to include instructions for performing a method. The method comprising recording magnetic responses from two or more suitable sensors disposed at locations with different magnetic field strengths in the regions of interest, and correlating all the said received magnetic responses to one or more material qualities of the said hysteretic ferromagnetic material. Correlating can include, but is not limited to, correlating all the said received magnetic responses to a material phase. Correlating can also include, but is not limited to, correlating all the said received magnetic responses to a material flaw. A variation of this embodiment includes performing similar measurement on a hysteretic ferromagnetic material that has been degaussed. The method can include sending an indicator signal if the detected material quality deviates from the acceptable range of material quality. The method can also include sending an indicator signal in real time to remote user if the detected material quality deviates from the acceptable range of material quality. The method can also include recording an indicator signal for later retrieval or download for post-processing and follow-up actions if the detected material quality deviates from the acceptable range of material quality.

To quantify the relation between the received magnetic responses from the sensors and the air gap thickness, the peak magnetic flux versus the air gap thickness is shown in FIGS. 3A-3B. The experimental data and computer simulation results are shown in FIGS. 3A and 3B, respectively. FIG. 3A shows the experimental data of peak magnetic flux for the different thicknesses of air gap. The peak magnetic flux amplitude is the difference between the maximal magnetic flux in FIG. 2B and the averaged magnetic flux measured away from the flaw region. FIG. 3B shows computer simulation results for peak magnetic flux amplitude versus the air gap thickness. The computer simulation results are consistent with the experimental data as shown in FIG. 3A.

Both experimental data and computer simulation show the linear dependence of the magnetic flux peak as a function of the air gap thickness. Moreover, the numerically calculated slope of the linear dependence of magnetic flux peak versus air gap thickness agrees well with the experimental measurements. Both experimental measurements and computer simulations show that the relation between the magnetic response and the size of air gap (which simulates a metal loss feature or a crack) is about 9 Gauss/100 μm. This excellent agreement between the experiment and computer simulation validates the simulation computer code.

In FIGS. 3A and 3B, the validity of computer simulation results for the magnetic flux density measurement of the center sensor 103 are demonstrated. Next, experiments and computer simulation were performed to validate computer code that simulates the magnetic measurements using both the center sensor 103 and the trailing sensor 105. These experiments and computer simulations are described in the following paragraphs.

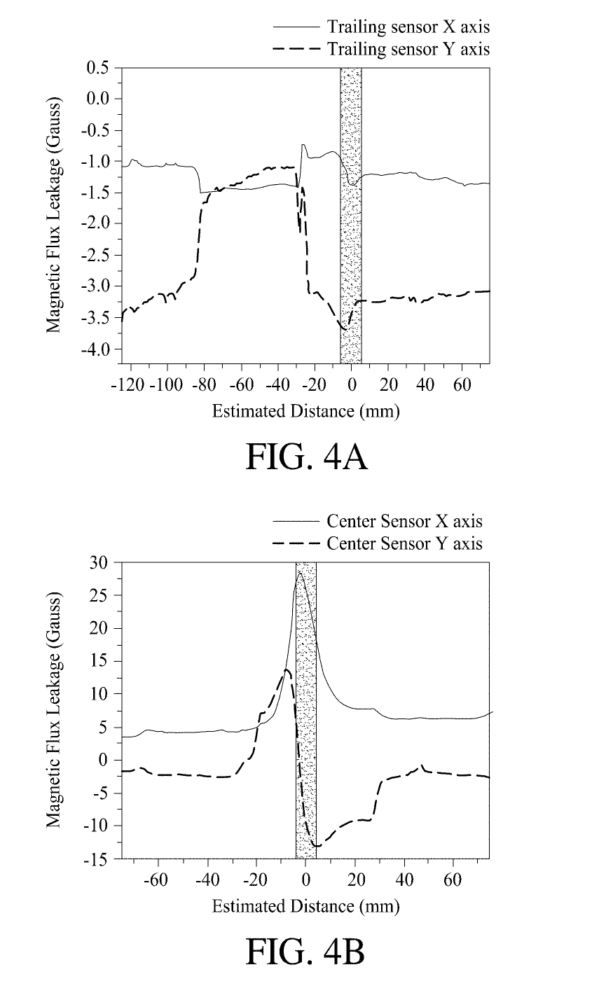

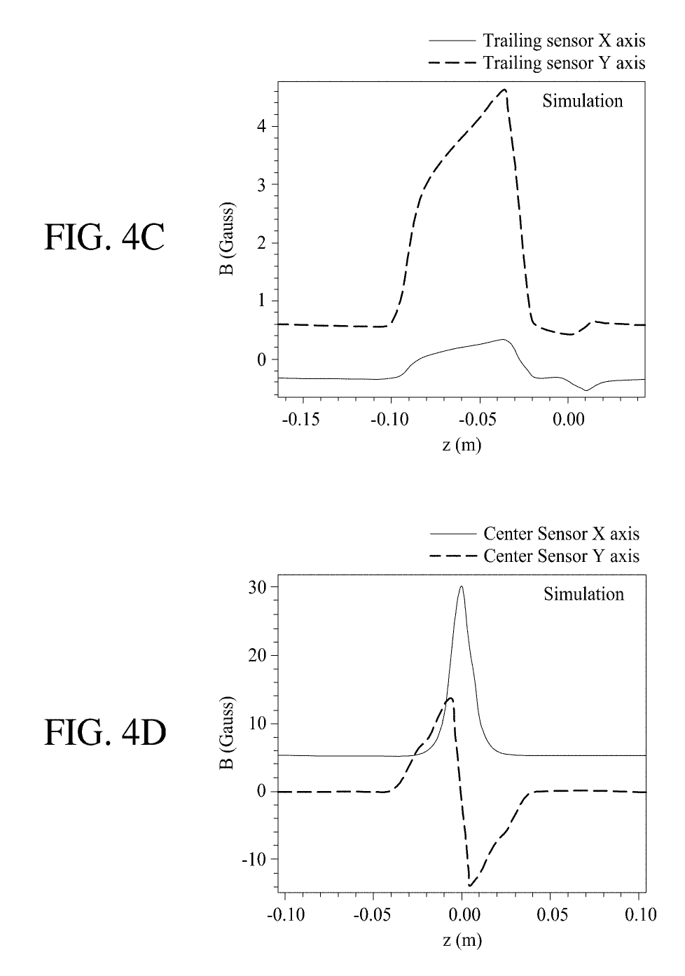

Referring to FIGS. 4A-4D, the magnetic flux density measured along the X-axis and Y-axis with a 308 μm air gap 113 is shown. The experimental results are shown in FIGS. 4A and 4B, and the computer simulation results are shown in FIGS. 4C and 4D. FIGS. 4A and 4C plot the magnetic flux density measured by the trailing sensor 105 and FIGS. 4B and 4D plot the magnetic flux density measured by the center sensor 103. In FIGS. 4A-4D, the black curve shows the magnetic flux density along the X-axis, e.g., the moving direction of the permanent magnet 101, while the red curve shows the magnetic flux density along the Y-axis, e.g., the direction perpendicular to the surface of the material 115 (e.g., a carbon steel bar) as shown in FIG. 2A.

In both FIGS. 4A and 4C, the trailing sensor 105 are starting to detect a magnetic anomaly when the front of permanent magnet 101 reaches the location of the air gap. On the one hand, both the experiment and the computer simulation results show that the measured magnetic flux leakage there is a wide hump in the Y-axis trailing sensor 105. On the other hand, both the experiment and the computer simulation results show that the measured magnetic flux leakage along the X-axis is insensitive to the presence of the air gap, with only 0.5 Gauss magnetic anomaly.

The magnetic flux densities along the X-axis and Y-axis of the center sensor 103 are plotted in FIGS. 4B and 4D. Both the experiment and the computer simulation results show symmetric and relatively narrower magnetic responses along the X-axis but anti-symmetric and relatively wider magnetic responses along the Y-axis. The results in FIGS. 4A-4D show quantitative consistency between the experiment and simulation, which further validates the computer simulation code. Note that the baseline magnetic flux density measured in the experiment, the flat region in the responses, is different from the computer simulation, which is due to the unknown residual magnetic field in the carbon steel bar 115.

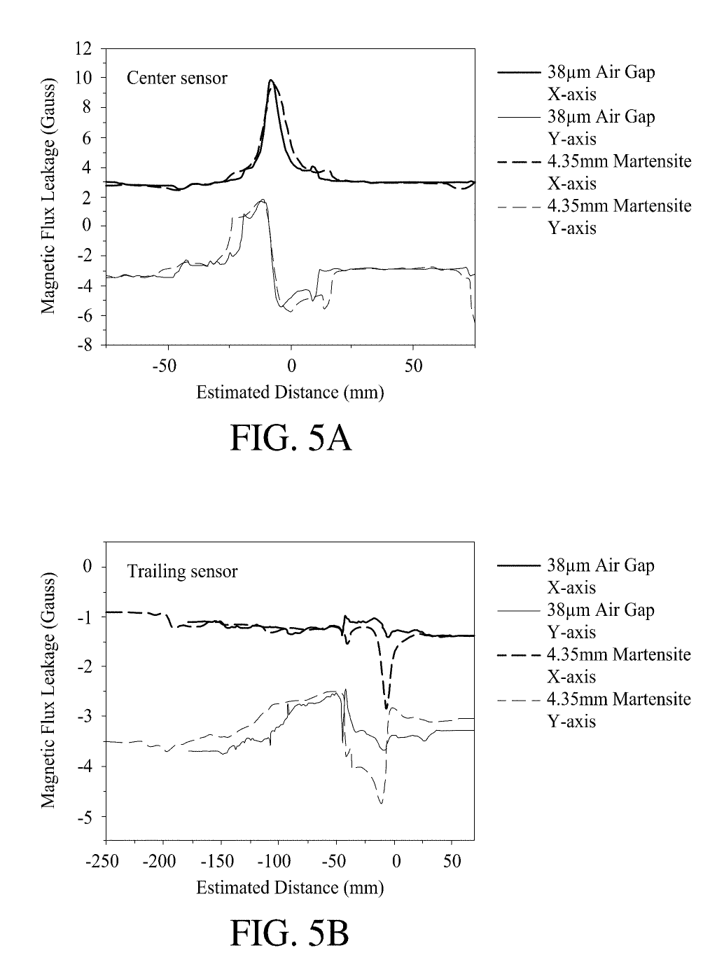

Using experimental setup shown in FIG. 2A, experiments were performed to measure magnetic flux leakage caused by a flaw 113, using center sensor 103 and trailing sensor 105, for the cases of using an air gap or a martensite coupon as the flaw. The experiment results are shown in FIGS. 5A and 5B. FIG. 5A shows the magnetic flux leakage measured by the center sensor 103. The solid curves correspond to the case with the 38 μm air gap as the flaw 113, and the dashed curves correspond to the case with the 4.35 mm hard martensite coupon as the flaw 113.

The measurement by the center sensor 103 probes the differences in the magnetic permeability between the flaws and the soft ferrite phases. Both the air gap and hard phases have a smaller magnetic permeability than soft ferrite phases. It has also been shown in FIGS. 3A and 3B that the magnetic anomaly is proportional to the size of the flaw. Therefore, the magnetic responses measured by the center sensor could show very similar signatures between the air gap and the hard phase. The results in FIG. 5A demonstrated the difficulties in distinguishing the hard phase from the corrosion metal loss or cracks if only using single point magnetic measurement.

In FIG. 5B, the magnetic responses measured by the trailing sensors, which show distinctive magnetic signatures between the air gap and the hard phase, are shown. Specifically, the X-axis magnetic flux density measured by the trailing sensor is insensitive to the presence of air gap while the same measurement in the presence of the martensite coupon experiences a significant dip that can be used as a distinguishing magnetic signature to identify the hard phase. In addition, the hard phase causes a trough and then a peak in the Y-axis magnetic flux density measurement around the location of the flaws as shown by the dashed green curve in FIG. 5B, whereas the magnetic response in the presence of air gap is rather flat near the location of the flaws. The dramatic differences in the magnetic responses measured by the trailing sensors between the air gap and the martensite phase can be due to the fact that the air gap is a linear magnetic material with a constant magnetic permeability while the magnetic permeability of the martensite phase is highly nonlinear and depends on the magnetic states that it experienced. Comparing FIGS. 5A and 5B, to distinguish the hard phase from the corrosion metal loss or crack, a multi-point sensing technique can be used that measures the magnetic properties of the materials at different points on the hysteresis loop.

After establishing the validity of the computer simulation tool as described above, by demonstrating the consistency between the results from experiments and computer simulations, in next step this computer simulation was used to demonstrate the feasibility of using the multi-point sensing and low magnetic flux technique for differentiating between the ferrite and the martensite/metal-loss-feature in a realistic pipe geometry.

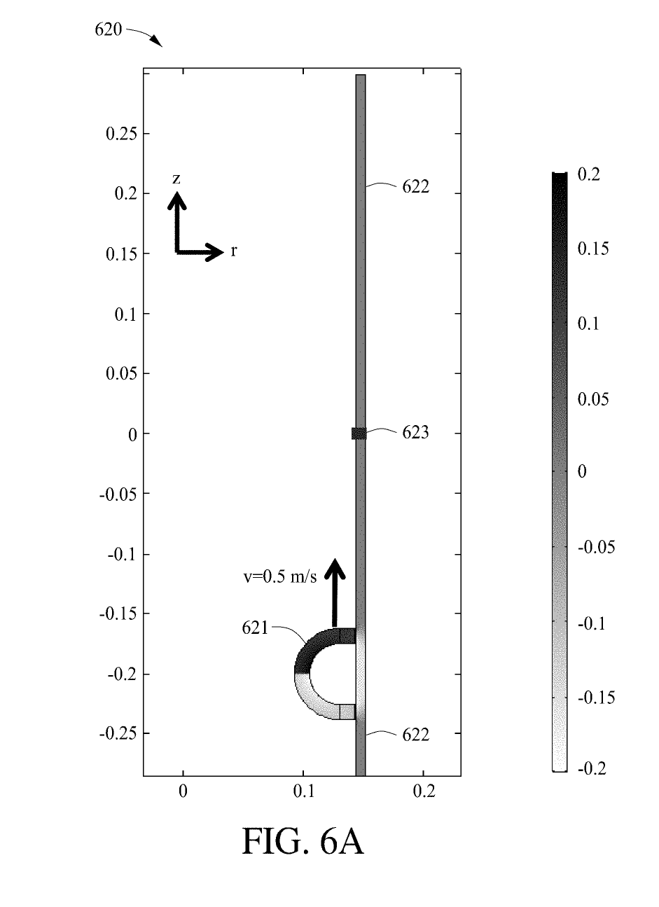

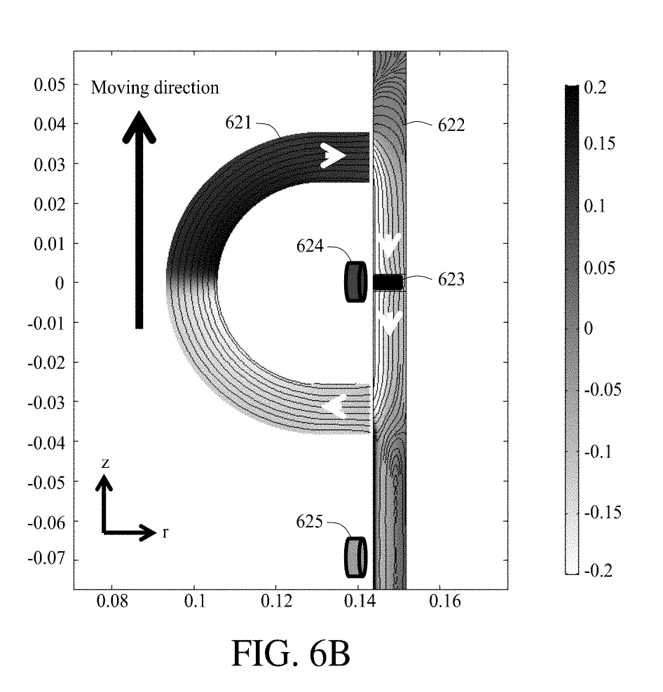

An embodiment of a geometry for the computer simulation is shown in FIGS. 6A-6B. The simulation was done for the axial symmetric geometry. FIG. 6A shows a schematic diagram of the system 620 with a horseshoe permanent magnet 621 moving along the pipe 622. The pipe 622 is axial symmetric with a radius of 15 cm and a thickness of 8 mm. The pipe is made of soft ferrite phase except for a region 623 representing flaws in pipeline. The magnetic flux in the pipeline 622 is created by a horseshoe permanent magnet 621 on the left surface of the steel pipe wall, and is moving at a speed 0.5 m/s along the z-direction. There is a region 623 in the steel pipe wall at z=0, which denotes a flaw, such as the hard phase or the metal loss or crack.

FIG. 6B shows a close-up view of FIG. 6A when the horseshoe permanent magnet 621 passes over the martensite phase/air gap 623. In the figure, the lines in the horseshoe permanent magnet 621 and pipe 622 denote the magnetic flux lines obtained from computer simulation described below. Two sensors, the center sensor 624 and trailing sensor 625, are placed at a location 1 mm away from the pipe wall surface, and both move together along with the horseshoe permanent magnet during inspection. The z-distance between the center sensor and the trailing sensor is 7 cm.

As shown in FIG. 6B, the magnetic flux density is finite in the region below the horseshoe permanent magnet 621 due to the hysteretic response of magnetic materials. This difference between soft ferrite and hard martensite in the hysteretic response can be used in distinguishing these two phases. In addition, the magnetic flux measured by the trailing sensors enables differentiating the hard phase from the metal loss feature because of the non-hysteretic response of the latter.

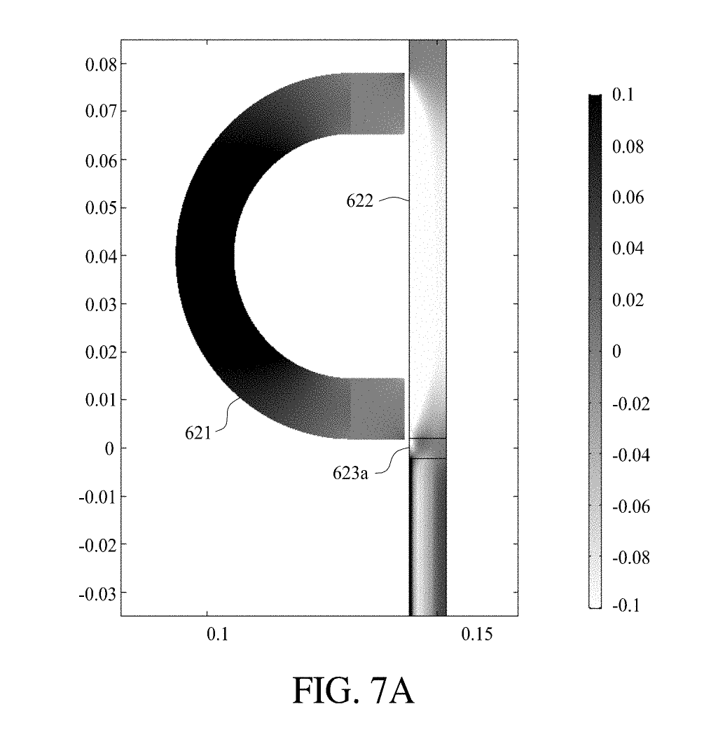

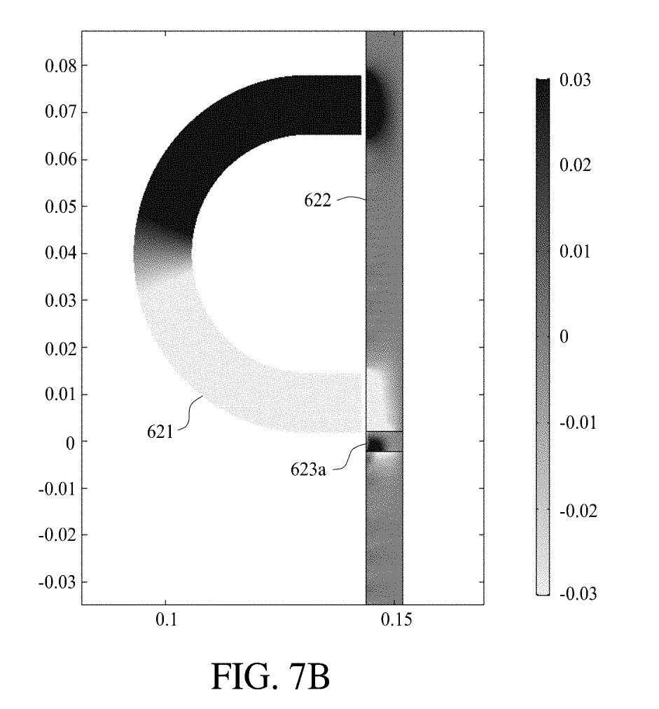

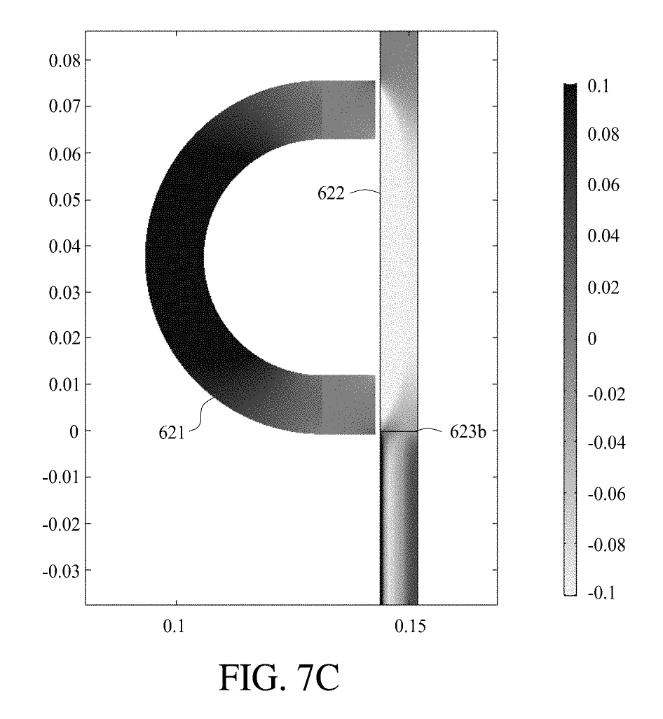

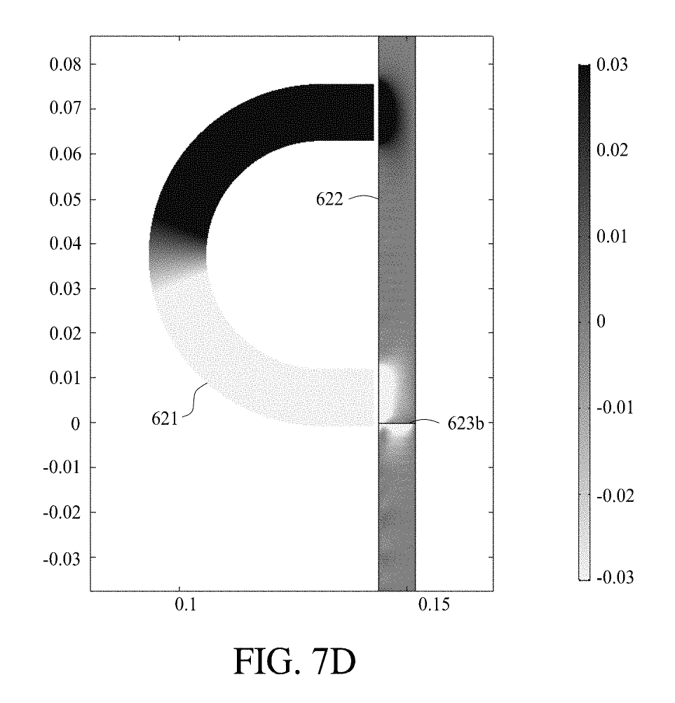

The COMSOL MULTIPHYSICS package was used to simulate the magnetic field strength when the horseshoe magnet 621 is moving vertically along the pipe wall at a speed of 0.5 m/s. FIGS. 7A-7D shows the spatially varying induced magnetic field when the permanent magnet 621 just passes the location of the flaws 623. FIGS. 7A and 7B correspond to the vertical z-component (Bz) and the horizontal r-component (Br) of magnetic flux density in the horseshoe magnet 621 and pipe wall in the presence of 4.35 mm martensite phase 623a, respectively. FIGS. 7C and 7D correspond to the vertical z-component (Bz) and the horizontal r-component (Br) of magnetic flux density in the presence of 38 μm air gap 623b, respectively.

The residual magnetic flux densities in the region below the location of the flaws show distinctive features between the hard phase 623a and the air gap 623b. This is due to the fact that the hard phase 623a is hysteretic whereas the air gap 623b is non-hysteretic. As a result, the trailing magnetic sensor can measure the different anomalous magnetic responses when passing through the martensite phase 623a or the air gap 623b.

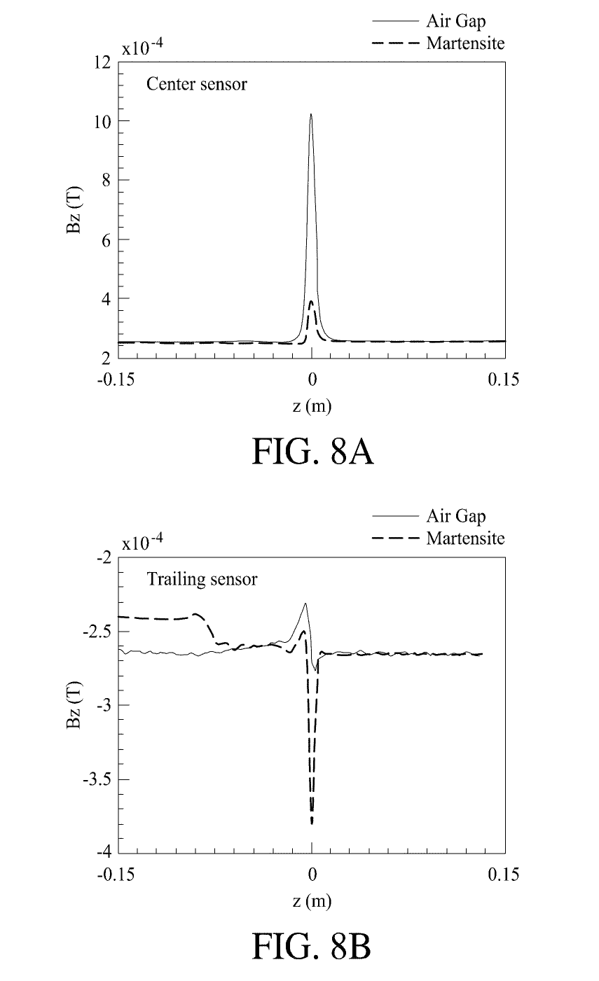

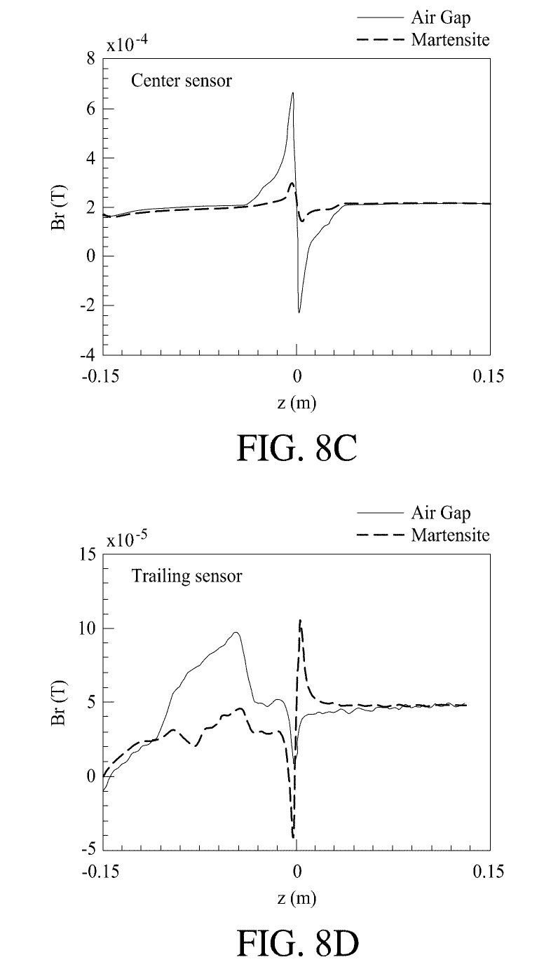

The simulated magnetic responses for martensite/air gap 623 detection are demonstrated in FIGS. 8A-8D. FIGS. 8A-8D plot the magnetic flux detected by the moving magnetic sensors. FIGS. 8A and 8B show a simulation of the vertical z-component (Bz) of magnetic flux measured by the magnetic sensor with maximum magnetic flux around 0.2 T in the pipeline. The results in FIGS. 8A and 8B correspond to the vertical-z-component (Bz) magnetic responses measured by the center sensor 624 and the trailing sensor 625, respectively. FIGS. 8C and 8D show the same simulation for the horizontal r-component of magnetic flux measured by the magnetic sensor. The results in FIGS. 8C and 8D correspond to the magnetic responses measured by the center sensor 624 and the trailing sensor 625, respectively. The solid curves show the simulation results in the presence of the air gap 623b while the dashed curves show results in the presence of the hard phase 623a. For the magnetic responses of the center sensor 624 shown in FIGS. 8A and 8C, both the air gap 623b and hard phase 623a give the magnetic anomaly in the measured magnetic response.

FIGS. 8A and 8C show that the air gap 623b and the martensite phase 623a induce qualitatively very similar features in the magnetic responses measured by the center sensor 624. The simulation results are consistent with the experimental measurement as shown in FIG. 5A. The hysteresis curve used in the computer simulation is slightly different from the real hysteretic properties of the martensite sample used in the experiment. In addition, the moving speed of the permanent magnet is about 1 cm/s in the experiment while the permanent magnet moves at 0.5 m/s in the computer simulation. These differences cause the quantitative differences between the experimental results and the simulation results when comparing FIG. 5A and FIGS. 8A/8C.

For the trailing sensor measurement as shown in FIG. 8B, the vertical-z-component magnetic anomaly in the presence of the hard phase 623a is more pronounced compared to that in the presence of air gap 623b. The sharp feature in the vertical-z-component magnetic flux density measured by the trailing sensor 625 due to the martensite 623a is consistent with our experimental data shown in FIG. 5B. Moreover, the magnetic measurement of the horizontal-r-component signifies the sharp difference between the air gap 623b and the hard phase 623a. Both vertical and horizontal components of the magnetic flux measured by the trailing sensor 625 show distinctive features between the air gap 623b and the martensite phase 623a. Therefore, incorporating multiple sensors in inline inspection can improve the reliability of detecting and differentiating the hard phase from the metal loss.

Both experimental and simulation results demonstrated the feasibility of multi-point sensing and low flux magnetic detection of the martensite phase. Moreover, the multi-point sensing technique makes it possible to detect and differentiate the hard phase from the metal loss.

As described above, embodiments can be applicable to differentiating various phases in steels used in pipelines, for example. Embodiments can also be used to identify metal loss and hard spots that are more prone to cracking and failure, which is an important component in pipeline integrity. Embodiments can enable detecting thin layers of a hard phase in steel plate mill inspection and differentiating hard spots from corrosion metal loss or crack. Embodiments of a method include extracting information from magnetic responses in steels under low magnetic flux modulation and measuring the strength of the magnetic field at different spots with multiple magnetic sensors.

The foregoing methods can be extended to the inspection of other steel components including, but not limited to, bolts, forgings, castings, and the like.

Embodiments utilize a multi-point sensing and low magnetic flux technique. The technique is based on the fact that soft and hard phases of steel (e.g., ferrite and martensite) experience different magnetic responses and hysteresis curves under low magnetic modulation. In addition, the use of a multi-point sensing technique allows measurement of magnetic responses of materials at different points on hysteresis curves.

Embodiments enable more robust detection of hard phase in soft ferrite steels and make it possible to differentiate hard phases from corrosion metal loss or cracks using low magnetic flux. Embodiments are capable of extracting magnetic properties at multiple points on the hysteresis curve, which improves the traditional capabilities for differentiating various metallurgic phases and metal loss in steel. Based on extensive laboratory experimentation and computer simulations, it has been found that unique magnetic responses that can distinguish different hysteretic materials, such as soft ferrite steel and hard steel. In addition, this multi-point sensing and low magnetic flux devices and methods can be used to inspect real pipeline steel and identify hard spots or metal loss with high fidelity, whereas existing devices and methods are only designed to detect metal losses and have been proven to be unreliable in identifying flaws such as a hard phase.

In accordance with at least one aspect of this disclosure, embodiments can be used without limitation for detection of hysteretic magnetic material phases in nonhysteretic materials. Nonhysteretic materials can include, but is not limited to, aluminum, austenitic stainless steel, duplex stainless steel, and high manganese steel. Example of hysteretic magnetic material phases include, but are not limited to, at least one of martensite, epsilon martensite, ferrite, pearlite, bainite, lath bainite, acicular ferrite, and quasi-polygonal ferrite. A first example application of the detection of hysteretic magnetic material phases in nonhysteretic materials includes determining an amount of magnetic ferrite content in duplex stainless steels (DSS), which can be used for grading the DSS or as a quality control measure. More specifically, the amount of delta ferrite in a ferrite-austenite DSS can be ascertained and used to grade the ferrite-austenite DSS or as quality control to determine if the amount of delta ferrite fall within desired range.

In yet another example, the detection of hysteretic magnetic material phases in nonhysteretic materials can be used for quality control when austenitic stainless steel (e.g., grades 304, 308, 316, and the like) weldments and austenitic stainless steel welds are exposed to high temperatures, for example, when refinery operating equipment such as piping, vessels, reactors, and weld overlays is exposed to hydrotreating conditions or hydroprocessing conditions. Under such conditions, the sigma phase of ferrite (a hysteretic magnetic material phase) can form, which causes the material to become brittle. The methods and devices described herein can be used to measure the amount of or detect the presence or absence of the embrittling sigma phase of ferrite in all or portions of the refinery operating equipment. In hydrotreating, typically, the refinery operating equipment and welds thereof contain austenitic stainless steels. In hydroprocessing, typically, the refinery operating equipment downstream of the reactor contains austenitic stainless steels, and the welds in refinery operating equipment upstream, in, and downstream of the reactor are contain austenitic stainless steels. The reactor in hydroprocessing is typically composed of Cr—Mo materials with austentic steel weld overlays. In some embodiments, the methods and devices described herein can also be used to measure the amount of or detect the presence or absence of ferrite content in girth and seam welds that are used for fabrication of austentic stainless steel piping, vessels and weld overlay of heavy wall Cr—Mo reactors in hydroprocessing reactors in D/S. The amount of ferrite content needs to meet a desired amount for preventing weld solification cracking in stainless steel weldments.

In each of the foregoing examples of detecting hysteretic magnetic material phases in nonhysteretic materials, calibration samples can be prepared with different amounts of hysteretic magnetic material phases in nonhysteretic materials to correlate the magnetic flux density signal to the amount or content of the hysteretic magnetic material phases.

In accordance with at least one aspect of this disclosure, embodiments can be used without limitation for characterizing the hardness of welds. Similar to the disclosure regarding FIGS. 13A-E, the VHN or Brinell Hardness number (BHN) of different weld materials can be correlated to the magnetic flux density signal described herein. In a first example of applying the characterization the hardness of welds, a handheld device can be used to measure the magnetic flux density signal to welds (new, old, or repaired) or portions thereof, which can then be correlated to a VHN and/or a BHN.

Another example of applying the characterization the hardness of welds is to identify the type of electric resistance weld (ERW) (e.g., low-frequency heat-treated ERW, low-frequency non-heat-treated ERW, high-frequency heat-treated ERW, and high-frequency non-heat-treated ERW). In this example, the magnetic flux density signal base pipe as compared to the magnetic flux density signal of the ERW can correlate to the type of ERW. Such correlation can be determined via standard calibration measurements. Implementation of such methods can be with in-line pipeline inspection gauges, automatic or manually pulled pipeline inspection tools, steel mill inspection tools, in-the-ditch inspection tools, handheld inspection devices, and the like. In yet another example of applying the characterization the hardness of welds is to identify the hardness of base pipe and the pipe grade using in-the-ditch inspection. In this example, the magnetic flux density signal can be calibrated and correlated to hardness, tensile and/or yield strength of the materials of base pipe. Such correlation can be used to determine the pipe grade using in-the-ditch inspection.

In yet another example of applying the characterization the hardness of welds, the hardness of welds (e.g., seam welds and/or girth welds) after repair. In one example, the repaired welds may be associated with pressure vessels (e.g., composed of Cr—Mo ½ Cr steels) used in hydrotreating and hydroprocessing reactors. The repair process can include removing the weld and a portions metal around the weld and replacing/patching the area. The newly formed welds can optionally be heat treated. The inspection process can include determining if the welds after repair (with or without post-weld heat treatment) meet industry standards and/or company specifications for the hardness of the weld and/or identify hard spots in the weld.

Another similar example includes measuring the hardness of welds associated with 21/4 Cr—V steel vessels. The inspection process can include determining if fabrication welds and/or welds after a repair (with or without post-weld heat treatment) meet industry standards and/or company specifications for the hardness of the weld and/or identify hard spots in the weld.

Yet another similar example includes management of weld hardness over time. That is, the vessels, pipes, and the like can be inspected over time monitoring the hardness and/or location and size of hard spots. Inspection can be carried out with any suitable device include handheld devices and automated crawlers. The inspection process can be performed on fabrication welds and/or repaired welds (with or without post-weld heat treatment).

In another embodiment of using the magnetic flux density signal correlated to weld hardness and/or hard spots in a weld, weld roots and/or weld caps specifically can be inspected and analyzed. In a preferred instance, this application can be applied to in-field welds of risers and sour service pipelines. Optionally, the inspection of root welds by the magnetic flux density signal methods/devices described herein can be conducted in combination with laser root profiling. Increased hardness in a root weld (e.g., a girth weld root) can originate from high cooling rates in an improper weld procedures (e.g., using Cu cooled shoes to close to the weld root) and/or dissolved Cu contamination in the weld metal from equipment such as Cu cooled shoes).

In yet another example of using the magnetic flux density signal correlated to weld hardness and/or hard spots in a weld, the quality of back welds can be assessed. Back welds are internal repairs to girth welds that are made manually. Determining the hardness and/or location and size of hard spots in a back welds can verify if the back weld meets the industry standards and/or company specifications for the hardness or determine if further repair is needed. Implementation of such methods can be with in-line pipeline inspection gauges, automatic or manually pulled pipeline inspection tools, handheld inspection devices, and the like.

In another example of using the magnetic flux density signal correlated to weld hardness and/or hard spots in a weld, methods and devices described herein can be used in conjunction with welding bugs used to produce girth welds and/or ultrasonic testing bugs used to inspect girth welds. Bugs are automated machinery that moves around the circumference of a pipe to produce girth welds and/or inspect girth welds. The devices described herein can be incorporated with bugs to measure the magnetic flux density signal of the girth weld after being formed (i.e., with a welding bug) or when also measuring the ultrasonic response of the girth weld (i.e., with an ultrasonic testing bug).

In accordance with at least one aspect of this disclosure, embodiments can be used without limitation for characterizing the hardness, tensile strength, and/or yield strength of the material used to produce or in pipes or similar structures. Similar to the disclosure regarding FIGS. 13A-E, the hardness (e.g., VHN or BHN), tensile strength, and/or yield strength of different materials used to produce or in pipes or similar structures can be correlated to the magnetic flux density signal described herein. Once a hardness, tensile strength, and/or yield strength is determined, the pipe grade can be derived. Implementation of such methods can be with in-line pipeline inspection gauges, automatic or manually pulled pipeline inspection tools, steel mill inspection tools, in-the-ditch inspection, handheld inspection devices, and the like.

In accordance with at least one aspect of this disclosure, embodiments can be used without limitation for detecting and locating hard zones (e.g., cold worked areas or dents) that can cause stress corrosion cracking that lower the integrity of pipeline and similar structures. Stress corrosion cracking is the formation of or growth of a crack in a corrosive environment. In austenitic stainless steel and aluminum alloys, chlorides (e.g., NaCl, KCl, and MgCl₂) can be the source of stress corrosion cracking. Stress corrosion cracking typically start with a small flaw in the surface that propagates under conditions where fracture mechanics predicts failure should not occur. Being able to detect stress corrosion cracking and or regions of local cold worked zones (hard zones) that can cause stress corrosion cracking with a nondestructive material inspection method or tool could mitigate the failure pipeline or other structures. Implementation of such methods can be with in-line pipeline inspection gauges, automatic or manually pulled pipeline inspection tools, handheld inspection devices, and the like.

As will be appreciated by those skilled in the art, aspects of the present disclosure may be embodied as a system, method or computer program product. Accordingly, aspects of the this disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of this disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but is not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but is not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but is not limited to wireless, wireline, optical fiber cable, RF, etc., or any suitable combination of the foregoing.

Computer program code for carrying out operations for aspects of this disclosure may be written in any combination of one or more programming languages, including an object oriented programming language such as Java, Smalltalk, C++ or the like and conventional procedural programming languages, such as the “C” programming language or similar programming languages, and visual programming languages, such as LabView, Igor or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the this disclosure are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified herein.

### Application of and Methods of Using Non-Destructive Material Inspection Systems

The methods and systems of the present disclosure, as described above and shown in the drawings, provide for nondestructive material inspection with superior properties. In one application, the methods and systems can be used as a nondestructive evaluation tool for in-line-inspection to identify one or more anomalies, flaws, and qualities in material being inspected. Examples of materials being inspected include, but are not limited to, steel plates, bolts, forgings, castings, pipes, risers, surfaces, welds, weld roots, weld caps, joints, and the like. Examples of anomalies, flaws, and qualities in samples that can be detected using the systems, devices, and method of the present invention include, but are not limited to, the hardness of welds and changes therein, the hardness of the material and changes therein used to produce or in pipes or similar structures, the grade of the material used to produce or in pipes or similar structures, the type of weld, the hardness of the material and changes therein, the presence of a material phase in the material (e.g., the presence of a hard steel phase such as martensite or bainite in carbon steel, nonhysteretic material phases in hysteretic ferromagnetic materials and hysteretic magnetic material phases in nonhysteretic materials), the presence of hard spots in the material, the presence of metal loss or cracks in the material (e.g., stress corrosion cracks), the presence of defects in the material, and combinations thereof.

In the above mentioned applications, the material phase can include, but is not limited to, at least one of austenite, martensite, ferrite, pearlite, bainite, lath bainite, acicular ferrite, and quasi-polygonal ferrite. In certain embodiments, the device can be incorporated onto nondestructive evaluation tools for detecting one or more material qualities of a sample composed of at least one hysteretic ferromagnetic material. Non-limiting examples of the nondestructive evaluation tools include in-line pipeline inspection gauges, automatic or manually pulled pipeline inspection tools, steel inspection tools and handheld inspection devices.

In certain embodiments, the application can include, but is not limited to, multiple copies of a magnet and two or more suitable sensors placed at a preferred nearby location of the sample.

In certain embodiments, the application can include, but is not limited to, a computer-controlled automatic moving platform to move the magnet and the two or more suitable sensors to detect magnetic responses at different spatial locations. In certain embodiments, the application can include, but is not limited to, a manually controlled translating and rotating platform to move the magnets and the two or more suitable sensors to detect magnetic responses at different spatial locations. In certain embodiments, the application can include, but is not limited to, a handheld device that includes at least one magnet and two or more suitable sensors. In certain embodiments, the sample in the application can include, but is not limited to, low-frequency heat-treated ERW pipes, low-frequency non-heat-treated ERW pipes, high-frequency heat-treated ERW pipes, and high-frequency non-heat-treated ERW pipes.

### Example Embodiments

A first example embodiment is a device for detecting one or more material qualities of a sample composed of at least one hysteretic ferromagnetic material, comprising: a magnet configured to provide a DC magnetic field which has a spatially varying magnetic field in at least a portion of the regions of interest, and two or more suitable sensors disposed at locations with different magnetic field strengths in the regions of interest configured to receive magnetic responses; and a processor, configured to execute a method, the method comprising: recording magnetic responses from two or more suitable sensors disposed at the said different locations; and correlating all the said received magnetic responses to one or more material qualities of the said sample composed of at least one hysteretic ferromagnetic material. Optionally, the device can include one or more of the following: Element 1: wherein the device includes an indicator configured to indicate to a user the one or more material qualities of the sample; Element 2: wherein the device can send indications in real time to a remote user through wireless communication technology; Element 3: wherein the device is configured to send indications in real time to a remote user through wireless communication technology; Element 4: wherein the device can record all indications for later retrieval and download either on-site or at remote locations for post processing; Element 5: wherein the device is configured to record all indications for later retrieval and download either on-site or at remote locations for post processing; Element 6: wherein the one or more material qualities include a material phase of the hysteretic ferromagnetic material or a non-hysteretic material; Element 7: Element 6 and wherein the non-hysteretic material can include air, aluminum, austenitic stainless steel, duplex stainless steel and high manganese steel; Element 8: Element 6 and wherein the material phase includes at least one of austenite, martensite, ferrite, pearlite, bainite, lath bainite, acicular ferrite, and quasi-polygonal ferrite; Element 9: wherein the sample includes at least two hysteretic ferromagnetic materials; Element 10: wherein the one or more material qualities include at least one of a material phase or a material flaw; Element 11: wherein the hysteretic ferromagnetic material includes steel, nickel, cobalt, silicon steel, and their alloys; Element 12: wherein the magnet includes one or more permanent magnets; Element 13: Element 12 and wherein the one or more permanent magnets form a horseshoe magnet; Element 14: wherein the magnet includes one or more electromagnets; Element 15: wherein the magnet to provide a DC magnetic field could be made of a combination of multiple types of magnets; Element 16: wherein at least one of the two or more suitable sensors is disposed in a center of the magnet; Element 17: wherein at least one of the two or more suitable sensors is disposed on the trailing side of the magnet; Element 18: wherein each of the two or more suitable sensors includes a multi-axis Hall sensor; Element 19: wherein the device also includes an optional degaussing system; Element 20: wherein the device can be embedded in a handheld tool and/or a computer-controlled automatic moving platform; Element 21: wherein recording magnetic responses from two or more suitable sensors includes recording the said magnetic responses real time with an on-board computer, and the method includes storing said magnetic responses at the time of signal acquisition to a computer readable storage media with sufficient information which can be used for post processing; Element 22: wherein the device can be incorporated onto computer-controlled automatic moving platform and signal processing can be performed either real time or post acquisition and storage; Element 23: Element 22 and wherein the device can be used as a nondestructive evaluation tool to screen metal plates and identify regions with higher hardness or metal loss or cracks; Element 24: wherein the device is incorporated onto computer-controlled automatic moving platform and signal processing can be performed either real time or post acquisition and storage; Element 25: Element 24 and wherein the device is used as a nondestructive evaluation tool to screen metal plates and identify regions with higher hardness or metal loss or cracks; Element 26: wherein the device can be incorporated onto a pipeline inspection gauge, for example, multiple copies of the said device could be incorporated to cover the circumference of the pipeline inspection gauge, and wherein signal processing is performed either real time or post acquisition and storage; Element 27: wherein the device can be used as nondestructive in-line-inspection tool to assess pipeline integrity; Element 28: wherein the device is incorporated onto a pipeline inspection gauge, for example, multiple copies of the said device could be incorporated to cover the circumference of the pipeline inspection gauge, and wherein signal processing is performed either real time or post acquisition and storage; and Element 29: wherein the device is used as nondestructive in-line-inspection tool to assess pipeline integrity. Example of combinations include, but are not limited to, one or more of Elements 12-15 in combination with one or more of Elements 16-18 and optionally in further combination with Element 19; one or more of Elements 1-5 in combination with one or more of Elements 12-15 and optionally in further combination with one or more of Elements 16-18 and optionally in further combination with Element 19; one or more of Elements 1-5 in combination with one or more of Elements 16-18 and optionally in further combination with Element 19; one or more of Elements 6-11 in combination with one or more of Elements 12-15 and optionally in further combination with one or more of Elements 16-18 and optionally in further combination with Element 19; one or more of Elements 9-11 in combination with one or more of Elements 16-18 and optionally in further combination with Element 19; one or more of Elements 9-11 in combination with one or more of Elements 1-5; two or more of Elements 1-5 in combination; two or more of Elements 6-11 in combination; two or more of Elements 12-15 in combination; two or more of Elements 16-18 in combination; and one of Elements 19-29 in combination with any of the foregoing.

Another example embodiment is a method for determining one or more qualities of a sample composed of at least one hysteretic ferromagnetic material, comprising: providing a DC magnetic field from a magnet to the said sample composed of at least one hysteretic ferromagnetic material; recording magnetic responses from two or more suitable sensors disposed at locations with different magnetic field strengths in the regions of interest configured to receive magnetic responses; and correlating all the said received magnetic responses to one or more material qualities of the said sample composed of at least one hysteretic ferromagnetic material. Optionally, the method can include one or more of the following: Element 6; Element 7; Element 8; Element 9; Element 10; Element 11; Element 12; Element 13; Element 14; Element 15; Element 16; Element 17; Element 18; Element 21; Element 30: the method further comprising moving the magnet and two or more suitable sensors together along a surface to be analyzed; Element 31: wherein correlating includes correlating all the said received magnetic responses to a material phase; Element 32: wherein correlating includes correlating all the said received magnetic responses to a material flaw; Element 33: the method further comprising sending an indicator signal to a user or send indications in real time to a remote user; Element 34: the method further comprising recording an indicator signal for later retrieval or download for post-processing and follow-up actions; Element 35: the method further comprising degaussing the hysteretic ferromagnetic material; Element 36: wherein the method is performed on a metal plate; and Element 37: wherein the method is performed with a pipeline inspection gauge. Examples of combinations include, but are not limited to, two or more of Elements 6-11 in combination; two or more of Elements 12-15 in combination; two or more of Elements 16-18 in combination; two or more of Elements 30-35 in combination; one or more of Elements 6-11 in combination with one or more of Elements 12-15 in combination and optionally in further combination with one or more of Elements 30-35; one or more of Elements 6-11 in combination with one or more of Elements 16-18 in combination and optionally in further combination with one or more of Elements 30-35; one or more of Elements 12-15 in combination with one or more of Elements 16-18 in combination and optionally in further combination with one or more of Elements 30-35; one or more of Elements 30-35 in combination with one or more of Elements 6-11; one or more of Elements 30-35 in combination with one or more of Elements 12-15; one or more of Elements 30-35 in combination with one or more of Elements 16-18; Element 21 in combination with any of the foregoing; and one of Elements 36 or 37 in combination with any of the foregoing.

Yet another example embodiment is a non-transitory computer readable medium, comprising instructions for performing a method, the method comprising: recording magnetic responses from two or more suitable sensors disposed at locations with different magnetic field strengths in the regions of interest; and correlating all the said received magnetic responses to one or more material qualities of the said sample composed of at least one hysteretic ferromagnetic material. Optionally, the non-transitory computer readable medium/method can include one or more of the following: Element 6; Element 7; Element 8; Element 9; Element 10; Element 11; Element 12; Element 13; Element 14; Element 15; Element 16; Element 17; Element 18; Element 21; Element 30; Element 31; Element 32; Element 33; Element 34; Element 35; Element 36; and Element 37. Examples of combinations include, but are not limited to, two or more of Elements 6-11 in combination; two or more of Elements 12-15 in combination; two or more of Elements 16-18 in combination; two or more of Elements 30-35 in combination; one or more of Elements 6-11 in combination with one or more of Elements 12-15 in combination and optionally in further combination with one or more of Elements 30-35; one or more of Elements 6-11 in combination with one or more of Elements 16-18 in combination and optionally in further combination with one or more of Elements 30-35; one or more of Elements 12-15 in combination with one or more of Elements 16-18 in combination and optionally in further combination with one or more of Elements 30-35; one or more of Elements 30-35 in combination with one or more of Elements 6-11; one or more of Elements 30-35 in combination with one or more of Elements 12-15; one or more of Elements 30-35 in combination with one or more of Elements 16-18; Element 21 in combination with any of the foregoing; and one of Elements 36 or 37 in combination with any of the foregoing.

While the device and method of the subject disclosure have been shown and described with reference to embodiments, those skilled in the art will readily appreciate that changes and/or modifications may be made thereto without departing from the spirit and scope of the subject disclosure.

1. A device for detecting one or more material qualities of a sample composed of at least one hysteretic ferromagnetic material, comprising:
a magnet configured to provide a DC magnetic field which has a spatially varying magnetic field in at least a portion of the regions of interest, and two or more suitable sensors disposed at locations with different magnetic field strengths in the regions of interest configured to receive magnetic responses; and
a processor, configured to execute a method, the method comprising:
recording magnetic responses from two or more suitable sensors disposed at the said different locations; and
correlating all the said received magnetic responses to one or more material qualities of the said sample composed of at least one hysteretic ferromagnetic material.

2. The device of claim 1, wherein the device includes an indicator configured to indicate to a user the one or more material qualities of the sample.

3. The device of claim 1, wherein the one or more material qualities include a material phase of the hysteretic ferromagnetic material or non-hysteretic material.

4. The device of claim 3, wherein the non-hysteretic material can include air, aluminum, austenitic stainless steel, duplex stainless steel and high manganese steel.

5. The device of claim 3, wherein the material phase includes at least one of austenite, martensite, ferrite, pearlite, bainite, lath bainite, acicular ferrite, and quasi-polygonal ferrite.

6. The device of claim 1, wherein the one or more material qualities include at least one of a material phase or a material flaw.

7. The device of claim 1, wherein the hysteretic ferromagnetic material includes steel, nickel, cobalt, silicon steel, and their alloys.

8. The device of claim 1, wherein the magnet includes one or more permanent magnets.

9. The device of claim 1, wherein the magnet includes one or more electromagnets.

10. The devices of claim 1, wherein the magnet to provide a DC magnetic field could be made of a combination of multiple types of magnets.

11. The device of claim 1, wherein at least one of the two or more suitable sensors is disposed in a center of the magnet.

12. The device of claim 1, wherein at least one of the two or more suitable sensors is disposed on the trailing side of the magnet.

13. The device of claim 1, wherein each of the two or more suitable sensors includes a multi-axis Hall sensor.

14. The device of claim 1, wherein the device also includes an optional degaussing system.

15. The device of claim 1, wherein the device can be embedded in a handheld tool and/or a computer-controlled automatic moving platform.

16. A method for determining one or more qualities of a sample composed of at least one hysteretic ferromagnetic material, comprising:
providing a DC magnetic field from a magnet to the said sample composed of at least one hysteretic ferromagnetic material;
recording magnetic responses from two or more suitable sensors disposed at locations with different magnetic field strengths in the regions of interest configured to receive magnetic responses; and
correlating all the said received magnetic responses to one or more material qualities of the said sample composed of at least one hysteretic ferromagnetic material.

17. The method of claim 16, further comprising moving the magnet and two or more suitable sensors together along a surface to be analyzed.

18. The method of claim 16, wherein correlating includes correlating all the said received magnetic responses to a material phase.

19. The method of claim 16, wherein correlating includes correlating all the said received magnetic responses to a material flaw.

20. A non-transitory computer readable medium, comprising instructions for performing a method, the method comprising:
recording magnetic responses from two or more suitable sensors disposed at locations with different magnetic field strengths in the regions of interest; and
correlating all the said received magnetic responses to one or more material qualities of the said sample composed of at least one hysteretic ferromagnetic material.
